(19) United States
(12) Patent Application Publication
(10) Pub. No.: US 2009/0144221 A1
(43) Pub. Date: Jun. 4, 2009

(54) DYNAMIC TIME-DIMENSION-DEPENDENT PHYSICAL MANAGEMENT ON DIVERSE MEDIA OF VERY LARGE EVENT-RECORDING DATA-STORE

(75) Inventors: David Harold Berk, Petach Tikva (IL); Aviad Sela, Yoqneam (IL); Uri Shani, Kiryat Motzkin (IL)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 11/949,478

(22) Filed: Dec. 3, 2007

(51) Int. Cl. G06F 17/30

(52) U.S. Cl. 707/1; 707/E17.001

(57) ABSTRACT

A database architecture system includes a database including a plurality of tables for storing data records having a time of creation and a time of arrival. A plurality of current tables include current data records and have their time of creation meeting a first specified creation time period, and their time of arrival meets a specified arrival time period. The current data records which meet a specified extraction time period after the first specified creation time period are extracted to files. Data records in current tables, having their time of creation overlapping the specified extraction time period are not updated during extraction, but are accessible for querying. The current data records having a time of creation not overlapping the specified extraction time period are accessible for querying and updating during extraction. The data records in the files are deleted when their time of creation meets a specified deletion time period.

### FIELD OF THE INVENTION

The present invention relates to management of large databases, and more specifically, relates to management of a large database with event-recording and storing records for a limited-time.

### BACKGROUND OF THE INVENTION

Current database management systems (DBMS) may be used for the management of a very large event-recording data-store or database. These databases may accept a continuous input stream of hundreds of millions of detailed records per day, each one may consist of dozens of fields and require loading into a database for retention. Retention of the records may be limited to a certain time period, such as 90 days, 1 year, etc. One of the fields is the event-time (ET) (time-stamp, or time of creation), which represents the time the event happened. When loaded to the database, this field is stored in one of the columns, herein termed the “Time dimension” (TD).

Current database implementations determine physical management mechanisms in accordance with attributes of physical container objects (i.e. table space) without regard to dynamically changing record age and state. Optimizing physical management mechanisms as a function of dynamically changing age and/or state of the records is not possible. This limitation may be due to inherent limitations of database management systems, or due to a lack of efficiency of the DBMS.

Examples of typical physical management optimization include extracting en masse a set of records which have aged beyond an initial retention period (IRP) (i.e., the time period between insertion to several successive days) to store in compressed files. Another management strategy includes massive automatic deletions of records whose archive-retention period (ARP) has elapsed. ARP is the time records are required to be retained, after which they may be deleted, or they are required by law to be deleted. Known DBMS may implement compression which is page-based using ZL (Ziv-Lempel) compression, or compression which compresses entire database tables and is also based on dictionaries using the ZL algorithm.

A disadvantage of existing database management system (DBMS) is that they can consume undesirable amounts of resources possibly causing query response degradation. In addition, very large database indexes are not compressed. Queries over a very large table, even when indexed, and when indexes depend on multiple columns, will quickly reduce to a sequential search on a very large candidate set, and thus slow query response dramatically.

Therefore, it would be desirable to optimize the management of large tables in a database including management of backup, query response and records insertion with large amounts of data records. Further, a need exists to reduce the volume of data in the database tables while continuing to be able to query and update tables.

### SUMMARY OF THE INVENTION

In an aspect of the invention, a database architecture system includes a database including a plurality of tables for storing data records including an event time which indicates a time of creation. The database indicates a time of arrival of each data record, and the database embodied in a computer readable medium stored in a computer. A plurality of current tables from the plurality of tables for saving current data records having the time of creation which meets a first specified creation time period and having the time of arrival which meets a specified arrival time period. The current data records in the current tables are accessible for querying, and updating. The current data records meet a specified extraction time period which is after the first specified creation time period are extracted to files. The current data records in the current tables from which the current data records are extracted to files are accessible for querying. At least one late arrival table from the plurality of tables for storing late arrival data records having the first specified creation time period and a time of arrival, and the creation time meets a specified late arrival time period which is defined at the time of arrival. The data records in the at least one late arrival table having the first specified creation time period overlapping the specified late arrival time period and are accessible for querying and accessible for updating. All current tables which are not late arrival tables and whose data records are extracted to file are blocked to deny updating of data records and deny entry of new data records, and the data records in the blocked current tables having their time of creation overlapping the specified late arrival time period. The data records from the blocked tables are extracted to additional files when their time of creation meets the specified extraction time period and the blocked table having all data records extracted being cleaned and reused by accepting new incoming data records. The data records being stored in the late arrival table being deleted when their time of creation meets a specified removal time period, and the data records in the files being deleted when their time of creation meets the specified removal time period.

In another aspect of the invention, a method for managing data in a database system includes: providing a plurality of tables for storing data records in a database embodied in a computer readable medium stored in a computer; determining a time of creation for each of the data records; selecting data records having the time of creation which meets a first specified time period of creation; saving current data records to a plurality of current tables having the time of creation which meets the first specified time period of creation; accessing and updating the data record in the current tables; inserting new data records having the time of creation which meets the first specified time period of creation; extracting the data records in the current tables when the data records meet a specified extraction time period being after the first specified creation time period; querying current data records in the current tables from which the current data records are being extracted to files; blocking at least one current table from which data records are extracted to files and which is not a late arrival table to deny updating of data records and deny entry of new data records; storing late arrival data records in at least one late arrival table from the plurality of tables, the late arrival data records having the first specified creation time period and the time of arrival meeting a specified late arrival time period, and the data records in the at least one late arrival table having the first specified creation time period overlapping the specified late arrival time period and being accessible for querying and for updating; extracting the data records from the late arrival table to additional files when their time of creation meets the specified extraction time period; and deleting the data records in the files and from the current tables and from the late arrival table when the data records time of creation meets a specified removal time period.

In a related aspect, the plurality of tables may be limited drastically to only two tables, one for current records and one for late arrivals. Data records in the current table having their time of creation overlapping a specified late arrival time period are extracted to files and deleted from the current table. Data records having time of creation overlapping a specified late arrival period at the time of arrival are inserted into the late arrival table. All changes to data records having their time of creation overlapping a specified late arrival time period are data records stored in the late arrival table.

In a related aspect, the late arrivals table may not be used and all data records which are considered late-arrivals are ignored and not stored at all. In one scenario, only one table may be used for current records, and all data records whose time of creation overlaps a specified late arrival time period at their time of arrival are ignored.

In a related aspect, the late arrival table may also be subject to extraction similarly as the tables holding current data records. In this case, this application suggests that the rate of data records which meet the criteria of late-arrival will be much smaller than that of current data records and that the plurality of late-arrival tables will be smaller and hence produce less data in the extracted files.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 is a block diagram according to an embodiment of the invention depicting a database system and data files;

FIG. 2 is a time line depicting a life-cycle of records in the database system shown in FIG. 1; and

FIG. 3 is a block diagram depicting a data record having fields.

### DETAILED DESCRIPTION OF THE INVENTION

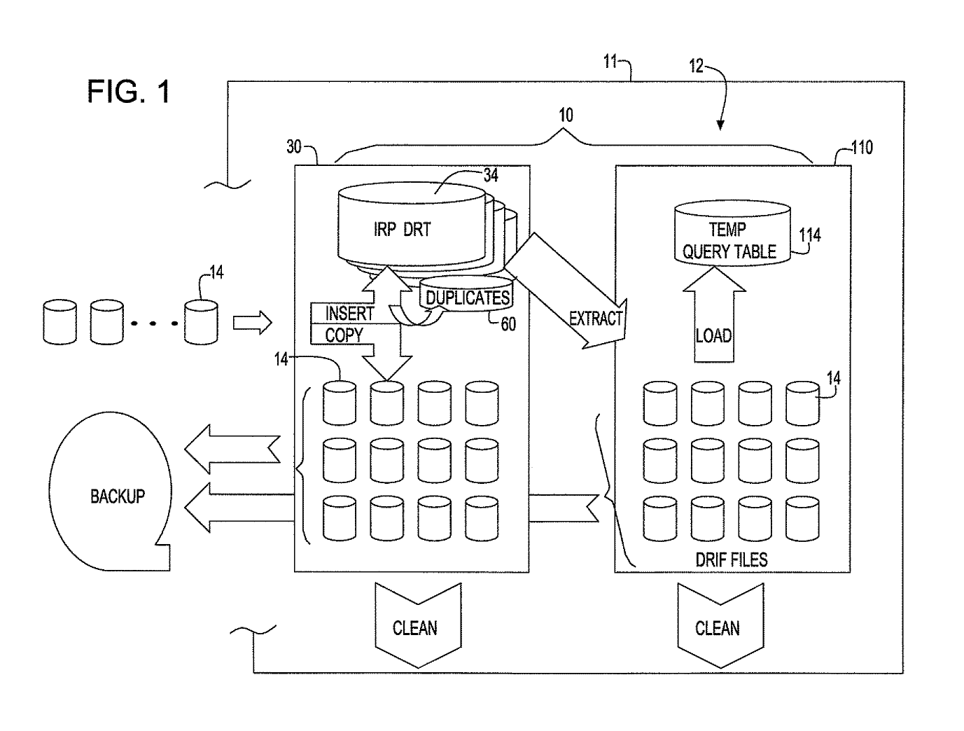

Referring to FIGS. 1-3, an illustrative embodiment of a database architecture system and method according to the present invention embodied as a database 10 for storing and retrieving data wherein terms used are defined as follows: event-time (ET) is the time the event happened; time dimension (TD) is a field of the data record stored in one of the columns, recording the ET; time period (TP) is a period of time; archive-retention period (ARP); dynamic initial retention period (DIRP) after which records are static and during which period records may be changed; query initial retention period (QIRP) is the period of time where the probability of access for a certain record drops dramatically after initial period; leading dimensions (LD) are known set of dimensions including TD; initial retention period (IRP) is a control parameter that is larger than the max(DIRP,QIRP); physical tables (P) are the plurality of tables which are part of the same logic table; the present time is referred to as NOW; a late-arrival boundary (LAB) which matches the DIRP; an initial retention period query boundary (IRPQB), where IRPQB<IRP<LAB, and a database management system (DBMS) is software for querying and managing a database.

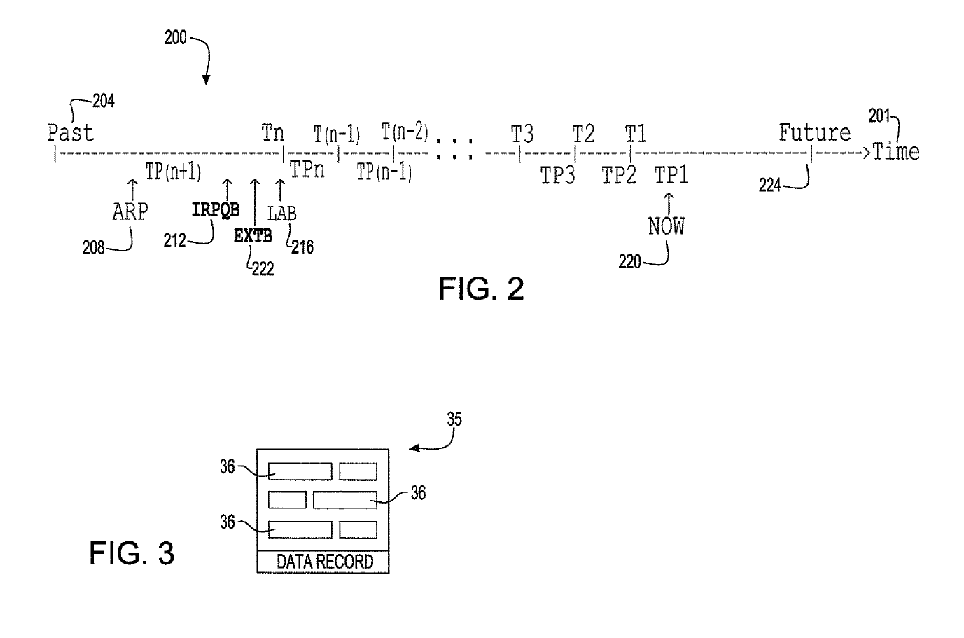

In general, referring to FIGS. 1-3, the present invention provides management of a very large event-recording data-store or database 10 including tables 34. The database 10 may accept a continuous input stream 14 of hundreds of millions of detailed data records 35 (shown in FIG. 3) in a day, each one may consist of dozens of fields 36 and load them into tables 34. In general, a single big table is divided into small tables 34 which are Physical Tables (P), all of which are part of the same Logical Table. Dividing the single big table into small tables is done according to the leading time-dimension (TD). The time line 201 (shown in FIG. 2) is divided into time periods (TP). Physical tables are assigned to the time periods in a continuous and controlled rolling activity (explained below) during which tables change states, but each keeps storing records of the same absolute TP as long as they are active. When tables become old they are transformed to another storage format, e.g., compressed files, where the files cannot be queried directly without some preparations, e.g., a prefetch operation. In addition, these files can be scanned directly for records meeting a certain “query” criteria. The activity of converting a physical table to compressed file is called “extraction”. The invention uses a synchronized database management system (DBMS) by which physical tables roll along a time line, are loaded with new records, undergo extraction, and are then cleaned and reused, as well as supporting queries to the data records.

More specifically, a database architecture system according to the present invention is embodied as a database 10 including a plurality of tables 34 for storing data records 14. The data records include an event time which indicates a time of creation. The database 10 indicates a time of arrival of each data record 14, and the database 10 is embodied in a computer readable medium 12 stored in a computer 11. A plurality of current tables are from the plurality of tables 34. The current tables, are for saving current data records having a time of creation which meets a first specified creation time period. The current data records also have a time of arrival which meets a specified arrival time period, and the current data records in the current tables are accessible for querying, and updating. The current data records which meet a specified extraction time period, which is after the first specified creation time period, are extracted to files.

In the embodiment of the present invention, time is divided into mainly three periods: a) NOW 220 which is greater than LAB 216, and the time period between NOW 220 and LAB 216 defines a first time period in the time dimension. Records having time of creation overlapping this time period are inserted and updated in the current active tables. b) LAB 216 which is greater than IRPQB 212 defines a second time period therebetween wherein there are two tables: a current table that is a candidate for extraction and which is blocked from updates (blocked current table), and a late-arrival table in which records are stored. The blocked current table may undergo extraction and will serve queries at the same time. Incoming data records having time of creation overlapping this time period are stored in the late arrival table. c) IRPQB 212 which is greater than ARP 208 and defines a third time period therebetween which is a period for which there are only late arrival tables (or only one late arrival table). Incoming data records having time of creation overlapping this time period are stored in the late arrival table, that is also used for queries. Other records having their time of creation overlapping this period have been extracted already and are in the files and cannot be updated, only queried or scanned.

Stated differently, the current data records in the current tables, having their time of creation older than LAB are candidates for extraction and are accessible for querying (but not updating). A late arrival table from the plurality of tables 34 is for storing late arrival data records and has a first specified creation time period and a time of arrival which meets a specified late arrival time period. The data records in the at least one late arrival table have the first specified creation time period overlapping the specified late arrival time period and are accessible for querying but not accessible for updating. The data records in the files are deleted when their time of creation meets a specified deletion time period.

In operation, referring to FIGS. 1 and 2, the data records 14 are stored in the plurality of tables 34 separated by their leading time-dimension (TD). The physical tables (P) can be grouped to be part of the same logical table to share the same fields and types, thereby defining a join view of all the tables in the group to provide the logical appearance of a single table. The physical tables are assigned time periods (TP) which divide the time line 200 (shown in FIG. 2), each time-period having two limits: T1 and T2. The notation TPi.T1 and TPi.T2 to denote the time limits T1 and T2 of the i-th TP, respectively. By convention, TPi.T2=TP(i+1).T1. The data records in the database 10 are assigned each to a certain TP as follows: records with event time ET (which is the value of the TD field in that record) belong to TPi such that TPi.T1<=ET<TPi.T2.

More specifically, NOW 220 is the present time and it constantly advances. NOW 220 will be within TP2, pass TP2.T2 (and TP1.T1), and advance along TP1. ARP 208 is set to sometime in the past, and should be within the TP(n+1) time period. LAB 216 is set to the T2 boundary of TP(n+1). Late arrival is defined by the LAB 216 and a late-arrival time period defined by TP(n+1). IRP 212 is set to sometime within the TP(n+1), later than LAB 216, and before the ARP 208 as will be further described below. It is assumed that records whose ET is older than IRPQB 212 are static, and they have a low probability to be queried (relative to records that are younger than IRPQB. Is it understood that it is always true that for these low probability records their ET<NOW−IRP, where IRP is a parameter.

For convention it is assumed, for example, that the length of time per TP (defined as TP.T2-TP.T1) is same for all TPs, and set to one day, however, it is understood that other time periods may be used, and in particular, the length of time assigned to TP(n+1) and to TP1 is “infinitely” large. It is also understood that individual TPs may have different lengths of time, and that in a special case, all TPs up to IRPQB may be merged into a single TP assigned to a single physical table, in which case a variation of this solution will be explained below. TP(n+1).T1 is Past 204 which is the minimal time-stamp possible in a DBMS. Likewise, TP1.T2 is Future 224 which is the largest a time-stamp that can be defined in a DBMS. Thus, Time 201 is divided from Past 204 to Future 201 to n+1 TPs, so that ARP 208 lies in TP(n+1) and NOW 220 can be configured to lie in either TP2 and TP1.

Additionally, two management constants, IRPdays, and ARPdays are, for example, IRPdays=7, ARPdays=90. Based on these values, the IRP 212, ARP 208 and LAB 216 terms (shown in FIG. 2) are computed as can be seen in Process Steps 1, lines 5, 6, 7 below. It is noted that the terms IRP and ARP have been used above as a generalization of the more specific terms IRPdays and ARPdays, respectively.

The TPs are updated (FIG. 1) whenever NOW 220 passes TP1.T1 (i.e., NOW—TP.T1 grows and approached 24 hours—one day, which is denoted as DAY in Process Steps 1 below), and as such the TPs are equal, and this occurrence is termed TP roll-up and proceeds as in Process Steps 1 below. It is understood that the above choice of 24 hours is not mandatory and can be generalized to any time period span:

Process Steps 1:

```
1. TP(n+1).T2 = TPn.T2
2. For each j in the range n down to 2 do
      2.a. TPj.T1= TPj.T2
      2.b. TPj.T2= TP(j−1).T2
3. TP1.T1 = nextDay(NOW), where nextDay(time) is the midnight of the
day in which “time” happens. nextDay(NOW) is today's midnight.
4. TP2.T2 = TP1.T1
-- Next steps set up the other time values: IRPQB, ARP, and LAB
5. LAB = TP(n+1).T2
6. IRPQB = min(TP1.T1 − IRPdays*DAY, LAB)
7. ARP = IRPQB − (ARPdays − IRPdays)* DAY
```

The setting of IRPQB 212 in step 6 depends also on physical table assignments to TPs. After step 3, T2 will include NOW 220 until midnight of the roll-up date. At the next day, NOW 220 will be within TP1. The physical tables 34 whose union represents the logical table are assigned to the TPs in a mapping M so that M(Pi)=TPj, where Pi is the i-th physical table. A physical table Pk for which M(Pk)=nil is inactive, otherwise the table is active. Inactive tables of tables 34 do not receive inserts of new records, and they may undergo certain maintenance activities until they can be reused for a new assigned TP. Before an inactive table can be re-assigned to a TP, it is cleaned of all contents and becomes empty. While an inactive table is processed and cleaned, and before it becomes clean it is in several states, starting with “ready for extraction”, then in the “process of extraction”, and finally “extracted”.

The state changes of physical tables from and to the active state is part of the P roll-up management activity (see Process Steps 2 below), which is performed at the same time as the TP roll-up activity (see Process Steps 1 above) so that the time range of records stored in a physical table is the same as long as it is active A special late arrival physical table (LAP) is defined in the physical tables 34 to keep all late-arrivals, meaning all records which arrive when their event-time ET satisfies a late arrival time period defined by: ET<Tn=TPn.T1=TP(n+1).T2=LAB 216, and the LAP is always active.

The P roll-up activity proceeds as in Process Steps 2 below:

Process Steps 2:

```
1. For each j in the range n down to 2 do
      1.a M(inverseM(TPj)) = TPj−1
2. Pick an “empty” table Pk
      2.a M(Pk) = TP1
```

The boundaries of the time-period within which the ET of all records of physical table P fall are denoted by P.T1 and P.T2, then these values do not change for as long as the table is assigned to any TP via the mapping M. Thus, these values may be used rather than the formula M(Pj)+T1 and M(Pj).T2. Inactive tables which hold records maintain the property of P.T1<=R.ET<P.T2. Thus, all physical tables PJ which are not active, but contain real records and their time of creation meets a specified extraction time, are in a state “ready for extract”, or in “process of extraction”, and are such that: IRPQB <=min(Pj.T1) over all such Pj. This rule, overrides step 5 of Process Steps 1 above (“TP roll-up”) as follows: actual IRPQB will be the minimal value of both. Therefore, all inactive physical tables meeting an extraction time period defined as a time-period which falls between IRPQB 212 and LAB 216 are in state “ready for extract”, “process of extraction”, or “extracted”. Further, a physical table meeting a deletion time period defined as PJ where Pj+T2<TRPQB can be erased and become clean and ready to be re-assigned and become active again for a newly defined TP1.

To perform a query on the logical table, all records R, where R.ET>=IRPQB are queried off their respective physical tables, while if R+ET<IRPQB, they require special prefetch of the records from their extracted media, or be scanned. Extraction is defined herein as ensuring that partially extracted physical tables can be extracted while queries are in progress. Extraction, in general terms means that some alteration of form is done on the tables that may vary between different DBMS systems which prepare these tables to become clean and not take part of the logical table they represent. These files are than compressed.

Prefetch is defined herein as records of clean physical tables, or such whose time-period is below IRPQB—that is: P.T2<IRPQB, and cannot be queried directly since they may be in a different form, or erased. When data records are extracted, they are moved into compressed files, and must be uncompressed and loaded to temporary tables from which they can be further queried. The LAP table is bound to any query whose time predicate overlaps past LAB 216 to the Past 204, as part of the union of active tables to be queried.

Due to the assumption that IRPdays is defined to reflect high probability for querying records which are inserted within that time period, compared with records which are older than that time, the overall expected cost of querying is not significantly higher than without it. In addition the smaller table sizes considered for querying ensures faster response due to smaller indexes and sheer table sized.

Extraction continues over inactive physical tables from old to new, that is, starting with IRPQB 212, continuing to the future 224. An extraction time boundary (EXTB) 222 can be used to define a present extraction time boundary so that extraction proceeds as in Process Steps 3 that follow:

Process Steps 3—Extraction:

```
1. EXTB = IRPQB
2. while (IRP < LAB)
      2.a. if there is a table P where P.T1 = EXTB
            2.a.1 set P state to “ process of extraction”
      2.b. set P to the only table with state “process of extraction”
      2.2. set newEXTB = EXTB + Step
      2.d. if P.T2 < newEXTB
            2.d.1. newEXTB = P.T2
      2.e. if newEXTB > LAB
            2.e.1. newEXTB = LAB
      2.f. if newEXTB == EXTB
            2.f.1. wait a while
            2.f.2. loop again
      2.g. extract records R of P where EXTB <= R.ET < newEXTB
      2.h. set EXTB = newEXTB
      2.i if EXTB = P.T2
            2.i.1 set state of P to “extracted”
```

Process Steps 3 can occur continuously while Process Steps 2 and Process Steps 1 occur and will not affect each other. For example, Process Steps 3 may work fast and will wait for the next roll-up to free a new physical table to become inactive which means ready for extract, and then continue.

It is understood that any extracted records can be retrieved back into the system according to a probability access function by the prefetch activity into a physical table in the query phase, and keep the information according to a Dynamic Retention Period (DRP) policy. Once the DRP is reached the physical table in the query phase can be silently drop/deleted/freed.

It is also understood that en-mass queries on records in the compressed files (i.e., those passed IRPQB 212 in FIG. 2) may proceed directly on the data in the files by a scanning function that matches records to a certain criteria, as an alternative to prefetching, and loading into a query table from which the matched records are selected using a conventional DBMS querying facility (i.e., SQL—Structured Query Language).

It is also understood that when inserting records to physical tables according to record ET, duplicate records can be easily identified when ET falls within the IRP time. There is a problem with identifying duplicates for records with older ET due to missing candidate records. That is an acceptable consequence for some applications. It is sometimes even common to disregard completely late-arrivals such as that, in which case there is no need for the LAP table at all.

It is further understood that late arrivals may not be negligible, in which case LAP table may become very large on its own and may require extraction and physical tables rolling as well.

Further, it is further understood that the plurality of physical tables may be reduced to a single table and that rolling tables as in Process Steps 1 will simply be reduced to changing the T1 and T2 boundaries of the TP assigned to this single physical table, and the reuse of cleaned physical tables is replaced with simply deletion of extracted data records from the single current table.

Thus, the present invention has numerous advantages which include being applicable to any DBMS (such as SQL Server® by Microsoft®, and MySQL open source, DB2® and Oracle®). Further, the present invention provides a 1:10 compression using files, which also reduces actual number of rows in live tables and in their indexes so that system management deals with a small fraction (about 1:14 or less) of rows compared with the full table. When the retention period is larger than the example used above, such as a full year (365 days) rather than 90, this ratio may reach 1:50 and more. In contrast, compression applied in various DBMS do not reduce indexes size. The present invention, compresses small subsets of the data without requiring reorganization of an entire table. Thus, in the present invention the information in the data records is always available. In various DBMS which apply compression, the mechanism is dependent on SQL® DML and cannot be used while other fact loading mechanisms are applied for massive loading. The present invention achieves greater compression efficiency than other DBMS compressions.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A database architecture system, comprising:
a database including a plurality of tables for storing data records having a plurality of fields wherein one of the fields includes an event time which indicates a time of creation, the database indicating a time of arrival of each data record, and the database embodied in a computer readable medium stored in a computer;
a plurality of current tables from the plurality of tables for saving current data records having the time of creation which meets a first specified creation time period and having the time of arrival which meets a specified arrival time period, and the current data records in the current tables being accessible for querying, and updating;
the current data records meeting a specified extraction time period being after the first specified creation time period are extracted to files, and the current data records in the current tables from which the current data records are extracted to files being accessible for querying and updating during extraction;
at least one late arrival table from the plurality of tables for storing late arrival data records having the first specified creation time period and the time of arrival which meets a specified late arrival time period, and the data records in the at least one late arrival table having the first specified creation time period overlapping the specified late arrival time period and being accessible for querying and accessible for updating; and
at least one current table which is not a late arrival table being blocked to deny updating of data records and deny entry of new data records, and the data records in the blocked current table having stored data records having their time of creation within the first specified creation time period and overlapping the specified late arrival time period, the data records from the blocked current table being extracted to additional files when their time of creation meets the specified extraction time period and the blocked table having all data records extracted being cleaned and reused by accepting new incoming data records, and the data records being stored in the late arrival table being deleted when their time of creation meets a specified removal time period, and the data records in the files being deleted when their time of creation meets the specified removal time period.

2. A method for managing data in a database system, comprising:
providing a plurality of tables for storing data records in a database embodied in a computer readable medium stored in a computer, the records having a plurality of fields wherein one of the fields includes an event time which indicates a time of creation;
determining a time of creation for each of the data records;
selecting data records having the time of creation which meets a first specified time period of creation;
saving current data records to a plurality of current tables having the time of creation which meets the first specified time period of creation;
accessing and updating the data record in the current tables;
inserting new data records having the time of creation which meets the first specified time period of creation;
extracting the data records in the current tables when the data records meet a specified extraction time period being after the first specified creation time period;
querying and updating current data records in the current tables from which the current data records are not being extracted to files;
blocking at least one current table which is not a late arrival table to deny updating of data records and deny entry of new data records, and extracting the data records in the at least one current table to the files;
deleting data records which have been extracted from the blocked current table after all data records in the table have been extracted or when the data records time of creation meets a specified removal time period;
storing late arrival data records in at least one late arrival table from the plurality of tables, the late arrival data records having the first specified creation time period and the time of arrival meeting a specified late arrival time period, and the data records in the at least one late arrival table having the first specified creation time period overlapping the specified late arrival time period and being accessible for querying but not being accessible for updating;
extracting the data records from the late arrival table to additional files when their time of creation meets the specified extraction time period; and
deleting the data records in the files from the current tables or from the late arrival table when data records time of creation meets the specified removal time period.
